(19) United States
(12) Patent Application Publication
(10) Pub. No.: US 2026/0330972 A1
(43) Pub. Date: Oct. 22, 2026

(54) SYSTEM AND METHOD FOR EMERGENCY MANAGEMENT OF TRAFFIC SIGNAL LAMP FAULTS BASED ON INTERNET OF THINGS LARGE MODEL

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Siwei ZENG, Chengdu (CN)

(73) Assignee: CHENGDU QINCHUAN IOT TECHNOLOGY CO., LTD., Chengdu (CN)

(21) Appl. No.: 19/690,109

(22) Filed: May 28, 2026

(30) Foreign Application Priority Data
Apr. 29, 2026 (CN) 202610579219.4

(51) Int. Cl. G08G 1/097; G06Q 10/20; G16Y 10/40

(52) U.S. Cl. CPC G08G 1/097; G16Y 10/40; G06Q 10/20

(57) ABSTRACT

Provided are a system and a method for emergency management of traffic signal lamp faults based on an Internet of Things large model. The method is executed by an emergency supervision and management platform of the system for emergency management of traffic signal lamp faults based on the Internet of Things large model, including: determining a status evaluation result of a signal lamp based on first monitoring data and second monitoring data of the signal lamp, wherein the first monitoring data and the second monitoring data are acquired by different sensing devices; determining a target signal lamp based on the status evaluation result, wherein the target signal lamp includes a faulty signal lamp and an abnormal signal lamp; cutting off a power supply of the faulty signal lamp, and issuing a detour suggestion to a target personnel; determining a fault prediction condition of the abnormal signal lamp based on the first monitoring data, the second monitoring data, and the status evaluation result of the abnormal signal lamp; and determining a maintenance parameter based on the fault prediction condition and sending the maintenance parameter to a maintenance personnel.

### CROSS-REFERENCE TO RELATED APPLICATIONS

This application claims priority to Chinese Application No. 202610579219.4, filed on Apr. 29, 2026, the entire contents of which are incorporated herein by reference.

### TECHNICAL FIELD

The present disclosure generally relates to a field of urban traffic signal lamp supervision, and in particular to a system for emergency management of traffic signal lamp faults based on an Internet of Things large model and a method for emergency management of traffic signal lamp faults based on an Internet of Things large model.

### BACKGROUND

In urban traffic, a signal lamp serves as a crucial component of traffic control. A fault of the signal lamp may cause traffic congestion, blockage, or even traffic accidents. Traditional fault detection for signal lamps generally adopts a form of manual periodic inspection or spot check. The traditional fault detection cannot respond to sudden signal lamp faults in a timely manner.

Therefore, there is an urgent need to provide a system for emergency management of traffic signal lamp faults based on an Internet of Things large model and a method for emergency management of traffic signal lamp faults based on an Internet of Things large model. The system and the method perform real-time detection on an operation status of a signal lamp in urban traffic. The system and the method determine whether a signal fault exists. The system and the method report related fault information to a traffic management department. The system and the method cut off a signal lamp that may have a fault. The system and the method intelligently adjust associated signal lamps of surrounding intersections to prevent traffic congestion.

### SUMMARY

One or more embodiments of the present disclosure provide a system for emergency management of traffic signal lamp faults based on an Internet of Things large model. The system includes an emergency supervision and management platform. The emergency supervision and management platform is configured to execute a method for emergency management of traffic signal lamp faults based on an Internet of Things large model.

One or more embodiments of the present disclosure provide the method for emergency management of traffic signal lamp faults based on the Internet of Things large model. The method is executed by the emergency supervision and management platform of the system for emergency management of traffic signal lamp faults based on the Internet of Things large model. The method includes: determining a status evaluation result of a signal lamp based on first monitoring data and second monitoring data of the signal lamp, wherein the first monitoring data and the second monitoring data are acquired by different sensing devices; determining a target signal lamp based on the status evaluation result, wherein the target signal lamp includes a faulty signal lamp and an abnormal signal lamp; cutting off a power supply of the faulty signal lamp and issuing a detour suggestion to a target personnel; determining a fault prediction condition of the abnormal signal lamp based on the first monitoring data, the second monitoring data, and the status evaluation result of the abnormal signal lamp; determining a maintenance parameter based on the fault prediction condition and sending the maintenance parameter to a maintenance personnel.

### BRIEF DESCRIPTION OF THE DRAWINGS

The present disclosure is further described in an exemplary manner through embodiments, which are described in detail with reference to the accompanying drawings. These embodiments are not restrictive. In these embodiments, the same reference numerals denote the same structures, wherein:

FIG. 1 is an exemplary schematic diagram of a system for emergency management of traffic signal lamp faults based on an Internet of Things large model according to some embodiments of the present disclosure.

FIG. 2 is an exemplary flowchart of a method for emergency management of traffic signal lamp faults based on an Internet of Things large model according to some embodiments of the present disclosure.

FIG. 3 is an exemplary schematic diagram of a first machine learning model according to some embodiments of the present disclosure.

FIG. 4 is an exemplary schematic diagram of control of an associated signal lamp according to some embodiments of the present disclosure.

### DETAILED DESCRIPTION

To more clearly illustrate the technical solutions of the embodiments of the present disclosure, the accompanying drawings required for the description of the embodiments are briefly introduced below. It is apparent that the accompanying drawings in the following description are merely some examples or embodiments of the present disclosure. For those of ordinary skill in the art, the present disclosure may also be applied to other similar scenarios based on the accompanying drawings without inventive efforts. Unless explicitly obvious from the context or otherwise specified, the same reference numerals in the drawings represent the same structures or operations.

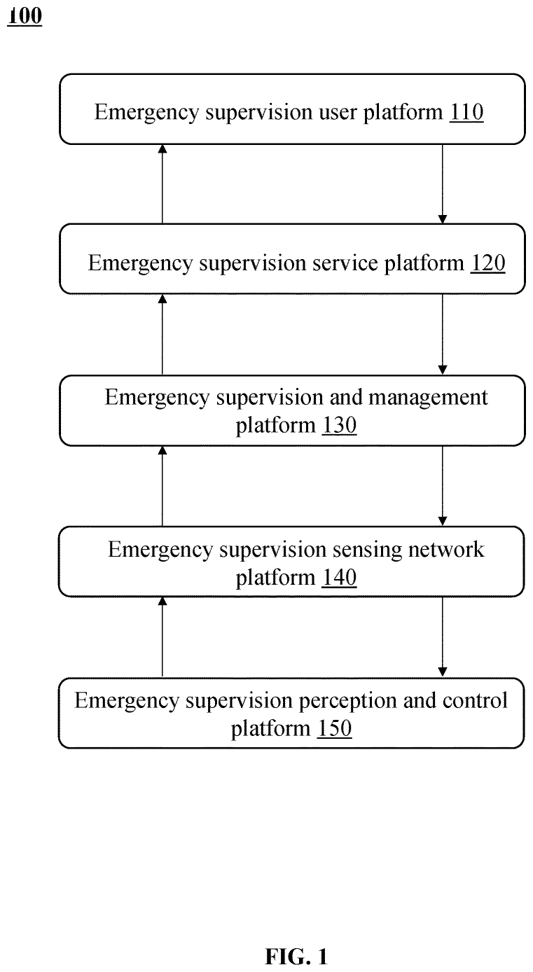

FIG. 1 is an exemplary schematic diagram of a system for emergency management of traffic signal lamp faults based on an Internet of Things large model according to some embodiments of the present disclosure. It should be noted that the following embodiments are merely for illustrating the present disclosure and do not constitute a limitation on the present disclosure.

In some embodiments, the Internet of Things large model refers to an Internet of Things model architecture, which can achieve efficient operation of a large amount of data in a system. Meanwhile, an Artificial Intelligence (AI) model may be applied to the Internet of Things model architecture to enhance the sensing and processing capability of data.

In some embodiments, as shown in FIG. 1, the system for emergency management of traffic signal lamp faults based on the Internet of Things large model 100 may include an emergency supervision user platform 110, an emergency supervision service platform 120, an emergency supervision and management platform 130, an emergency supervision sensing network platform 140, and an emergency supervision perception and control platform 150.

In some embodiments, one or more platforms of the system for emergency management of traffic signal lamp faults based on the Internet of Things large model 100 may exchange information and/or data through a network. In some embodiments, the network may be any one or more of a wired network or a wireless network.

The emergency supervision user platform 110 refers to a platform where a supervision user supervises the operation of an entire Internet of Things system. The supervision user may be personnel of a traffic safety management department, or the like. In some embodiments, the emergency supervision user platform may include at least one personnel interaction device. For example, mobile phones, computers, or the like. In some embodiments, the supervision user may real-time monitor a status evaluation result of signal lamps in a city traffic system through the emergency supervision user platform 110, thereby achieving full-domain status perception of the signal lamps in the city traffic system.

The emergency supervision service platform 120 refers to a platform configured to receive and transmit data and/or information. In some embodiments, the emergency supervision service platform 120 may be configured as a communication network, a gateway, or the like. In some embodiments, the emergency supervision service platform 120 may perform two-way data interaction with the emergency supervision user platform 110 and the emergency supervision and management platform 130. For example, the emergency supervision service platform 120 may receive a fault prediction condition of an abnormal signal lamp from the emergency supervision and management platform 130, and send the fault prediction condition of the abnormal signal lamp to the emergency supervision user platform 110, so that the supervision user can take corresponding emergency measures.

The emergency supervision and management platform 130 is a comprehensive management platform that manages, coordinates, and cooperates the connections among a plurality of platforms. The emergency supervision and management platform may be configured as a server or a processor. In some embodiments, the emergency supervision and management platform 130 is communicatively connected to the emergency supervision sensing network platform 140 and the emergency supervision perception and control platform 150.

In some embodiments, the emergency supervision and management platform 130 is configured to execute the method for emergency management of traffic signal lamp faults based on the Internet of Things large model.

The emergency supervision sensing network platform 140 is configured to comprehensively manage sensing information, and is a communication and transmission platform for realizing two-way data interaction between the emergency supervision and management platform 130 and the emergency supervision perception and control platform 150. In some embodiments, the emergency supervision sensing network platform 140 may be configured as a communication network, a gateway, or the like. The emergency supervision sensing network platform 140 is responsible for uploading real-time sensing data obtained by the emergency supervision perception and control platform 150 to the emergency supervision and management platform 130, and issuing regulation instructions generated by the emergency supervision and management platform 130 to the corresponding emergency supervision perception and control platform 150 for execution.

The emergency supervision perception and control platform 150 is a platform for generating supervision information and executing control information. In some embodiments, the emergency supervision perception and control platform 150 may include a plurality of monitoring, sensing, and interaction devices deployed at an intersection of the city traffic system, for example, a first sensor array, a roadside radar, a Vehicle to Everything (V2X) communication module, a smart camera, an Edge Computing Unit (ECU), the AI intelligent agent, or the like.

In some embodiments, the emergency supervision perception and control platform 150 may be pre-authorized by the emergency supervision and management platform 130 to analyze supervision information and perform analytical determination through an AI intelligent agent, and to generate regulation instructions.

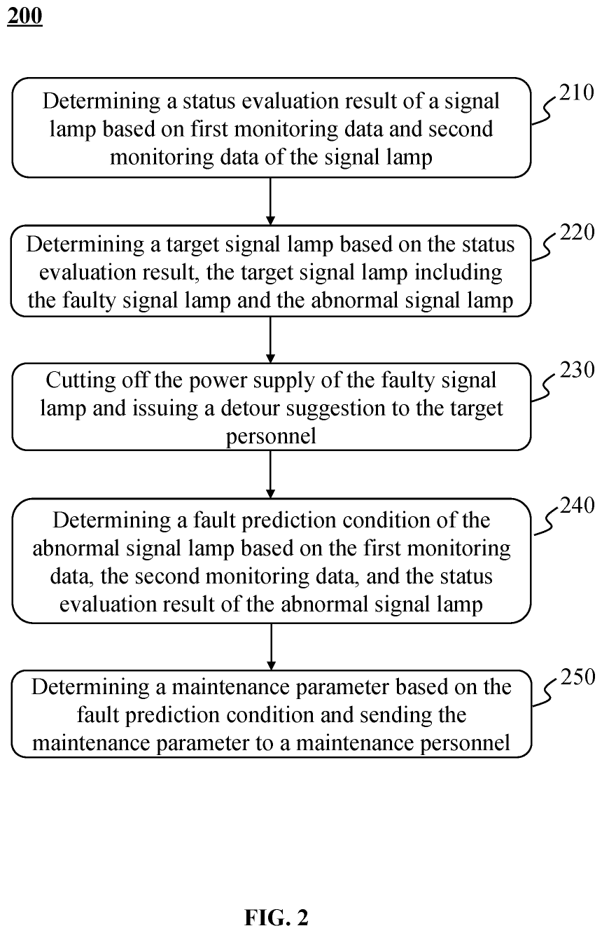

More details about the above-mentioned platforms may be referred to in FIGS. 2 to 4 and their related descriptions.

In the system for emergency management of traffic signal lamp faults based on the Internet of Things large model 100, communication connections may be achieved among the respective functional platforms. An information operation closed loop may be formed among the respective functional platforms, and the platforms may operate in a coordinated and regular manner under the unified management of the emergency supervision and management platform, thereby achieving informatization and intellectualization of traffic signal lamp fault supervision.

It should be noted that the above description of the system for emergency management of traffic signal lamp faults based on the Internet of Things large model 100 is merely for convenience of description, and should not limit the present disclosure to the scope of the disclosed embodiments.

FIG. 2 is an exemplary flowchart of a method for emergency management of traffic signal lamp faults based on an Internet of Things large model according to some embodiments of the present disclosure. As shown in FIG. 2, a process 200 includes the following steps. In some embodiments, the process 200 may be executed by the emergency supervision and management platform.

Step 210, determining a status evaluation result of a signal lamp based on first monitoring data and second monitoring data of the signal lamp.

The signal lamp refers to a traffic control device that transmits instructions for passing, stopping, or warning to road users through changes in specific color lights or graphic symbols. For example, motor vehicle signal lamps, pedestrian signal lamps, or the like.

In some embodiments, the first monitoring data and the second monitoring data of the signal lamp may be acquired by different sensing devices.

The first monitoring data refers to monitoring data acquired by a first sensor array. The first sensor array refers to a sensor combination deployed on the signal lamp. In some embodiments, the first sensor array may include a brightness sensor, a chromaticity sensor, a current sensor, a voltage sensor, a temperature sensor, an attitude sensor, an ambient light sensor, or the like.

In some embodiments, the first monitoring data may include brightness data, chromaticity data, electrical data, temperature data, attitude data, ambient light data, or the like. The brightness data refers to data acquired by the brightness sensor installed on red, yellow, and green light groups, which reflects a real-time brightness of each color lamp light. The light group refers to a light-emitting module including a plurality of bulbs. The chromaticity data refers to data acquired by the chromaticity sensor and used for determining a spectral deviation of a light color. The electrical data refers to data acquired by the current sensor and the voltage sensor, and used for monitoring a power supply status of each light group. The temperature data refers to data acquired by the temperature sensor, and used for monitoring an operating temperature of an interior of a lamp housing and each light group. The attitude data refers to data acquired by the attitude sensor, and used for monitoring a tilt or vibration status of a pole of the signal lamp. The ambient light data refers to data acquired by the ambient light sensor, and used for monitoring an ambient light intensity of the intersection.

The second monitoring data includes monitoring data acquired by a second sensor. The second sensor refers to a sensor installed in an area of the intersection where the signal lamp is located. In some embodiments, the second sensor may include a high-definition camera, a millimeter-wave radar, a Light Detection and Ranging (LiDAR), or the like.

In some embodiments, the second monitoring data may include visual data and the traffic flow data. The visual data refers to actual status information of the signal lamp acquired by the high-definition camera, for example, a color of the signal lamp, a flashing mode, or the like. The traffic flow data refers to traffic parameters of the intersection where the signal lamp is located, such as real-time vehicle queue length, vehicle speed, and traffic flow, or the like. In some embodiments, the traffic flow data may be obtained by the millimeter-wave radar or the LiDAR.

In some embodiments, the second monitoring data may further include communication data.

The communication data refers to data acquired by the V2X communication module based on the intersection where the signal lamp is located, and includes data generated during communication between the V2X communication module and passing vehicles of a corresponding intersection (e.g., vehicles having On-Board Diagnostics (OBD) data, such as buses, taxis, or the like).

The status evaluation result refers to a conclusive evaluation or determination obtained after analyzing a status of the signal lamp. In some embodiments, the status evaluation result includes a fault status and an abnormality degree. The abnormality degree refers to a degree of deviation from a normal status.

In some embodiments, the status evaluation result may include three conditions: the signal lamp being in a normal status, the signal lamp being in a fault status, and the signal lamp being in an abnormal status. The normal status refers to the signal lamp being fully functional, and no intervention is required. The fault status refers to the signal lamp being unable to operate normally, and must be immediately intervened and repaired. For example, the signal lamp being completely off, a cable being open-circuited, or being unable to switch colors according to instructions, or the like. The abnormal status refers to an operating status where one or more operating parameters in first monitoring parameters or second monitoring parameters of the signal lamp deviate from a historical normal baseline of the signal lamp, but have not yet caused a complete loss of functionality.

In some embodiments, the emergency supervision and management platform may compare the first monitoring data and the second monitoring data of the signal lamp with various parameters of historical first monitoring data and historical second monitoring data corresponding respectively to a normal status, an abnormal status, and a faulty status of the signal lamp within historical data, and determine the status evaluation result of the signal lamp.

In some embodiments, the emergency supervision and management platform may further determine an initial evaluation result of the signal lamp based on the first monitoring data; verify the initial evaluation result based on the second monitoring data; and use the initial evaluation result that passes the verification as the status evaluation result.

The initial evaluation result refers to a conclusion obtained by the emergency supervision and management platform after performing a preliminary analysis and determination of the status of the signal lamp based on the first monitoring data.

In some embodiments, the emergency supervision and management platform may determine the initial evaluation result based on the first monitoring data in various ways. For example, the emergency supervision and management platform may, based on historical data and relevant professional knowledge, define a safe range or an abnormal trigger condition for a plurality of types of data in the first monitoring data (brightness data, chromaticity data, electrical data, temperature data, attitude data, and ambient light data, or the like). The emergency supervision and management platform may store the safe range or the abnormal trigger condition in the ECU, and control the ECU to determine the initial evaluation result based on the safe range or the abnormal trigger condition.

The abnormal trigger condition may include: a current of the light group in the signal lamp suddenly decreasing beyond a preset threshold or decreasing to zero, or a signal lamp brightness continuously falling below 30% or more of a normal value within a preset duration, or the like. The preset threshold and the preset duration may be preset by technical personnel based on experience.

In some embodiments, the emergency supervision and management platform may control the ECU to compare whether the plurality of types of data in the first monitoring data of the signal lamp are within the safe range, to determine the initial evaluation result. For example, if any one type of the plurality of types of data in the first monitoring data of the signal lamp is not within the safe range, it may be preliminarily determined that the signal lamp is in a fault status, or it may be preliminarily determined that the signal lamp is in an abnormal status, and a corresponding abnormality degree may be determined based on a specific data value and the safe range.

In some embodiments, when the first monitoring data of the signal lamp triggers the abnormal trigger condition, it may be preliminarily determined that a fault exists in the signal lamp, or it may be preliminarily determined that an abnormality exists in the signal lamp.

For example, the emergency supervision and management platform may, based on historical data, use a historical average brightness value of the signal lamp in a normal status under different ambient light intensities as a historical brightness baseline. The emergency supervision and management platform may control the ECU to compare real-time brightness data of each lamp panel of the signal lamp and a current real-time ambient light intensity with the historical brightness baseline of the signal lamp under a corresponding ambient light intensity. If the real-time brightness data continuously falls below the historical brightness baseline, the signal lamp is marked as having a brightness abnormality, and the abnormality degree is determined based on a degree of deviation between the real-time brightness data and the historical brightness baseline. The historical brightness baseline may be preset by technical personnel based on experience.

As another example, the emergency supervision and management platform may control the ECU to monitor current and voltage data of each light group of the signal lamp in real time. If the current of the light group of the signal lamp suddenly drops to zero, it is preliminarily determined as an open circuit fault. If the current of the light group of the signal lamp continuously exceeds the safe range, it is determined that the signal lamp is in a fault status (e.g., an overload or short circuit abnormality). The historical brightness baseline may be preset by technical personnel based on experience.

As still another example, the emergency supervision and management platform may control the ECU to monitor a temperature of an interior of a signal lamp housing and an Light-Emitting Diode (LED) module. If the temperature of the interior of the signal lamp housing and the LED module continuously exceeds a safe threshold, the signal lamp is marked as having an overheat abnormality, and it is determined as a heat dissipation system fault or an internal component abnormality.

As still another example, the emergency supervision and management platform may control the ECU to monitor the attitude data of the signal lamp. If a continuous tilt or vibration of the signal lamp beyond a preset attitude threshold is detected, it is determined as a signal lamp structure abnormality, which may be caused by a collision or a loose pole body. The preset attitude threshold may be preset by technical personnel based on experience.

In some embodiments, the emergency supervision and management platform may control the ECU to compare the first monitoring data of signal lamps of the same type (e.g., all red signal lamps) at the same intersection, in the same direction, or in an adjacent direction. If the first monitoring data of a signal lamp among them deviates from an average value of the same data of the signal lamps of the same type by a degree exceeding the preset ratio (e.g., 30%), it may be preliminarily determined that the signal lamp is in a fault status, or it may be preliminarily determined that the signal lamp is in an abnormal status, and a corresponding abnormality degree is determined. A preset ratio may be preset by technical personnel based on experience.

In some embodiments, the emergency supervision and management platform may compare and verify the initial evaluation result generated by the ECU with the second monitoring data. For example, the emergency supervision and management platform may perform visual verification and traffic flow verification on the initial evaluation result and the second monitoring data.

The visual verification refers to a quantitative and objective verification process performed on the initial evaluation result generated by the ECU by using video or image information in the second monitoring data.

In some embodiments, the emergency supervision and management platform may, according to an intersection smart camera and by a computer vision algorithm, identify an actual luminous status of the signal lamp (color and brightness) in real time, and then perform visual verification on the initial evaluation result and the second monitoring data.

For example, if the initial evaluation result indicates that a green light brightness of a light group of the signal lamp is low, and an analysis result of the visual algorithm shows that the green light brightness of the light group is low, then the initial evaluation result passes the verification. If the analysis result of the visual algorithm shows that the green light brightness of the light group is normal, then the initial evaluation result fails the verification, and the initial evaluation result is marked as questionable.

As another example, if the initial evaluation result indicates that a current of a light group of the signal lamp is zero (i.e., the signal lamp is not lit), and an analysis result of the visual algorithm shows that the light group is not lit, then the initial evaluation result passes the verification. If the analysis result of the visual algorithm shows that the light group has brightness, then the initial evaluation result fails the verification, and the initial evaluation result is marked as questionable.

The traffic flow verification refers to a quantitative and objective verification process performed on the initial evaluation result generated by the ECU by using the traffic flow data in the second monitoring data through data comparison and logic analysis.

In some embodiments, the emergency supervision and management platform may, according to a roadside radar, monitor traffic flow data, and then perform traffic flow verification on the initial evaluation result and second monitoring data.

For example, if the initial evaluation result indicates a green light brightness abnormality of a light group of the signal lamp, and the traffic flow data shows that an increase in queue length in a passing direction of the green light exceeds a length threshold and a decrease in traffic efficiency exceeds an efficiency threshold, then the initial evaluation result passes the verification. If the traffic flow data shows no obvious change in the queue length and the traffic efficiency in the passing direction of the green light (i.e., the increase in queue length does not exceed the length threshold and the decrease in traffic efficiency does not exceed the efficiency threshold), then the initial evaluation result fails the verification, and the initial evaluation result is marked as questionable.

In some embodiments, the emergency supervision and management platform may determine the status evaluation result based on the verification result of the initial evaluation result and the second monitoring data.

In some embodiments, if the initial evaluation result passes the verification and the initial evaluation result indicates that the signal lamp is in the fault status (e.g., a current of a lamp panel of the signal lamp is zero), then the signal lamp is marked as a faulty signal lamp. If the initial evaluation result passes the verification and the initial evaluation result indicates that the signal lamp is in the abnormal status (e.g., a brightness of a lamp panel of the signal lamp is low), then the signal lamp is marked as an abnormal signal lamp, and a specific abnormality degree is uploaded.

In some embodiments, if the initial evaluation result fails the verification, the initial evaluation result is marked as questionable, and a data acquisition frequency of the signal lamp is increased. Simultaneously, an alarm is sent to the emergency supervision and management platform, requesting a further deep diagnosis (e.g., manual or more complex machine learning model intervention).

In some embodiments of the present disclosure, on the one hand, through a hierarchical verification evaluation process, the system can output an accurate and reliable status of the signal lamp. On the other hand, by utilizing external and independent sensor data to cross-verify internal data of the signal lamp itself, an accuracy of fault determination is greatly improved. This can effectively avoid false positives and missed reports caused by single sensor damage or data drift, thereby ensuring a reliability of a final status evaluation result.

Step 220, determining a target signal lamp based on the status evaluation result.

The target signal lamp refers to a signal lamp identified as needing attention in the status evaluation. In some embodiments, the target signal lamp includes the faulty signal lamp and the abnormal signal lamp.

The faulty signal lamp refers to a signal lamp that has failed. In some embodiments, the faulty signal lamp is a signal lamp for which the status evaluation result is the fault status. The abnormal signal lamp refers to a signal lamp that has abnormal data, but for which a fault has not yet been confirmed. For example, a signal lamp of which parameters, such as brightness, chromaticity, current, or temperature, or the like, exceed a normal value range, but that has not yet lost its illumination function. The abnormal data refers to monitoring data that exceeds the normal value range. In some embodiments, the abnormal signal lamp is a signal lamp for which the status evaluation result is the abnormal status.

In some embodiments, the emergency supervision and management platform may determine signal lamps for which the status evaluation result is the fault status and the abnormal status as the target signal lamps, based on the status evaluation result.

In some embodiments, the emergency supervision and management platform may determine the abnormal signal lamp through the following steps.

Step 1, data preprocessing and data fusion.

The preprocessing refers to operations such as data cleaning, data formatting, and time series alignment, or the like, performed on raw data acquired by various sensors.

The data fusion refers to a process of cooperatively processing and integrating data from a plurality of sensors or information sources.

Step 2, real-time status monitoring. The real-time status monitoring refers to acquiring and analyzing real-time data of the signal lamp and its related parameters, so as to timely determine whether abnormal conditions occur.

In some embodiments, the emergency supervision and management platform may compare the first monitoring data and the second monitoring data with a preset threshold range, and determine abnormal data. The abnormal data refers to data that does not satisfy the preset threshold range. The preset threshold range includes normal range values respectively corresponding to the brightness data, the chromaticity data, the electrical data, the temperature data, the attitude data, the ambient light data, the visual data, and the traffic flow data.

In some embodiments, the emergency supervision and management platform may determine the preset threshold range based on the ECU, historical data, and a statistical analysis of signal lamp normal operation. The ECU refers to an embedded device deployed on a lamp body of the signal lamp and having data processing and communication capabilities. In some embodiments, signal lamps of a plurality of adjacent intersections may share a single ECU for control, or a signal lamp may correspond to an ECU.

Step 3, local fault prediction. In some embodiments, when the real-time status monitoring finds abnormal data, the emergency supervision and management platform may determine the signal lamp corresponding to the abnormal data as an abnormal signal lamp.

In some embodiments, for the abnormal signal lamp, the emergency supervision and management platform may determine the abnormality degree of the abnormal signal lamp based on a difference between the abnormal data and the preset threshold range.

For example, the emergency supervision and management platform may compare actual brightness data of the abnormal signal lamp with the preset threshold range for the brightness data corresponding to the abnormal signal lamp, and determine an absolute value of a minimum difference between the actual brightness data and the end values of the range as the abnormality degree of the abnormal signal lamp. The determination manner of the abnormality degree for data such as the chromaticity data, the electrical data, or the like, is similar.

In some embodiments, the emergency supervision and management platform may perform fusion processing on the abnormality degrees corresponding to various data of the abnormal signal lamp to determine a final abnormality degree of the abnormal signal lamp. For example, the emergency supervision and management platform may first perform normalization processing on the abnormality degrees corresponding to various data of the abnormal signal lamp, and then perform a weighted summation, using the summation value as the final abnormality degree of the abnormal signal lamp.

In some embodiments, a determination of the abnormal signal lamp is related to a traffic flow of an intersection where the abnormal signal lamp is located and a historical accident count.

The traffic flow of an intersection refers to a count of motor vehicles passing within a unit time. In some embodiments, the traffic flow of the intersection may be obtained by devices such as loop detectors, high-definition cameras, millimeter-wave radars, LiDARs, or the like, of the intersection.

The historical accident count refers to a count of traffic accidents occurring at the intersection within a preset statistical period. In some embodiments, the historical accident count may be obtained from a traffic accident database or a command and dispatch platform of a traffic management department.

In some embodiments, the abnormal signal lamp is a signal lamp that has not failed but for which the abnormality degree in the status evaluation result exceeds a second abnormality threshold and is lower than a first abnormality threshold. The first abnormality threshold and the second abnormality threshold corresponding to signal lamps at the same intersection are the same. The first abnormality threshold is greater than the second abnormality threshold.

In some embodiments, the first abnormality threshold may be automatically generated based on a difference between the first abnormality threshold and the second abnormality threshold empirically preset by a person skilled in the art, after determining the second abnormality threshold.

In some embodiments, the emergency supervision and management platform may determine the second abnormality threshold of the abnormal signal lamp according to the following formula (1):

$${T}_{2} = {T}_{1} * \frac{{Q}_{2}}{{Q}_{1}} * \frac{{V}_{2}}{{V}_{1}} * {e}^{- N} . \qquad ( 1 )$$

In formula (1), T₂ represents the second abnormality threshold; T₁ represents a reference threshold, wherein in some embodiments, the reference threshold is manually preset; Q₁ and V₁ respectively represent a historical traffic flow and a historical average vehicle speed of the intersection where the abnormal signal lamp is located within a preset historical period; Q₂ and V₂ respectively represent a traffic flow and an average vehicle speed of similar intersections of the intersection where the abnormal signal lamp is located; and N represents the historical accident count of the intersection where the abnormal signal lamp is located. The similar intersections refer to intersections similar to the intersection where the abnormal signal lamp is located in terms of road grades, lane structures, or the like.

In some embodiments of the present disclosure, the first abnormality threshold and the second abnormality threshold are dynamically adjusted according to a traffic status of the intersection, making the system more intelligent and capable of more accurately identifying potential faults of high-risk intersections.

Step 230, cutting off the power supply of the faulty signal lamp and issuing a detour suggestion to the target personnel.

In some embodiments, after identifying the faulty signal lamp, the emergency supervision and management platform may send a cut-off instruction to the ECU corresponding to the faulty signal lamp, cutting off the power supply of the faulty signal lamp to eliminate traffic congestion and safety hazards caused by the extreme fault of the signal lamp. The extreme fault refers to conditions such as a signal lamp continuously illuminating a color lamp, or the like.

In some embodiments, after performing the power cut-off operation, the ECU may feed back status information that the power supply has been cut off to the emergency supervision and management platform through communication networks such as Fifth Generation (5G), Narrow Band Internet of Things (NB-IoT), or fiber optics, or the like. The emergency supervision and management platform generates a maintenance work order, and notifies the maintenance personnel through manners such as system messages, Short Message Service (SMS) messages, or emails, or the like.

The target personnel refers to vehicle drivers who may be heading to the intersection where the faulty signal lamp is located or who are approaching the intersection where the faulty signal lamp is located. For example, drivers of vehicles located at an upstream section of the intersection and drivers currently driving at the intersection, or the like.

The detour suggestion refers to an alternative path guidance, provided to affected traffic participants, based on real-time traffic data, and aimed at avoiding the intersection where the faulty signal lamp is located and optimizing a regional traffic flow.

In some embodiments, the emergency supervision and management platform may concurrently publish the detour suggestion through a plurality of channels. For example, navigation service platforms, in-vehicle terminals, traffic guidance screens, and mobile navigation APPs, or the like.

Step 240, determining the fault prediction condition of the abnormal signal lamp based on the first monitoring data, the second monitoring data, and the status evaluation result of the abnormal signal lamp.

For more details about the first monitoring data, the second monitoring data, and the status evaluation result, refer to Step 210 and its related description.

The fault prediction refers to predicting a fault type and a fault probability that may occur for the abnormal signal lamp. In some embodiments, the fault prediction condition includes the fault type and the fault probability. The fault type includes component aging, a communication abnormality, or the like.

The component aging refers to signs of performance degradation appearing in components of the signal lamp (such as bulbs, power modules, or the like) during long-term operation, but not yet reaching a degree that affects normal illumination or control functions. The component aging may include bulb aging, driving power supply performance degradation, clock crystal oscillator drift, or seal aging, or the like.

In some embodiments, the communication abnormality includes signal loss, an increased packet error rate, excessive delay, periodic interruptions, or the like.

In some embodiments, the emergency supervision and management platform may determine the fault prediction condition of the abnormal signal lamp based on the first monitoring data, the second monitoring data, and the status evaluation result of the abnormal signal lamp through a fault table.

In some embodiments, the emergency supervision and management platform may build the fault table based on historical first monitoring data, historical second monitoring data, and historical status evaluation results manually confirmed during maintenance, when a plurality of signal lamps have abnormal data in the historical data. The fault table includes a correspondence between different historical first monitoring data, historical second monitoring data, and historical status evaluation results.

The emergency supervision and management platform may determine the fault prediction condition of the current signal lamp by querying the fault table based on the first monitoring data, the second monitoring data, and the status evaluation result of the current signal lamp. By way of example, if it is statistically found in the historical data that the brightness of 95% of the signal lamps decreases to a range C during bulb aging, then the range C is written into the fault table as a determination basis for ‘bulb aging’, and the corresponding fault probability may be 95%.

In some embodiments, the emergency supervision and management platform may integrate a plurality of obtained faults and their corresponding fault probabilities, and select a fault type with the highest fault probability among them as the fault type of the fault prediction condition, and the corresponding fault probability as the fault probability of the fault prediction condition.

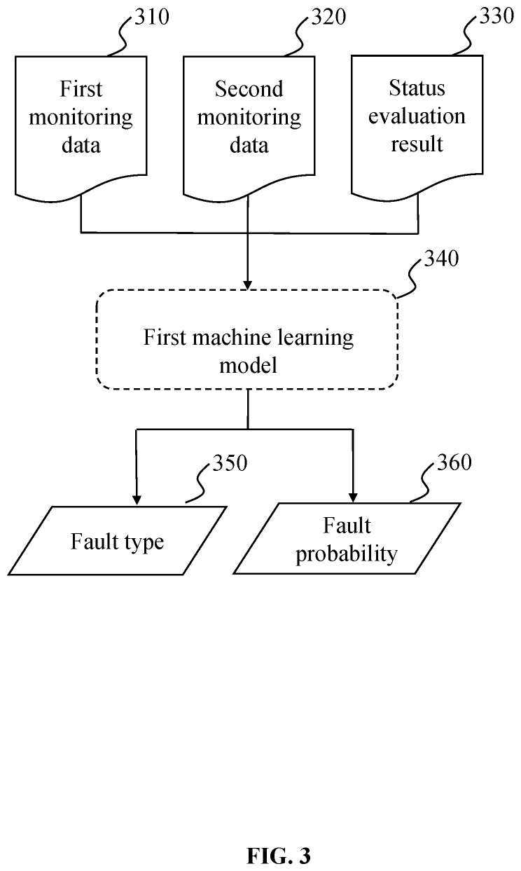

For more details on determining the fault type and the fault probability, refer to FIG. 3 and its related description.

Step 250, determining the maintenance parameter based on the fault prediction condition and sending the maintenance parameter to the maintenance personnel.

The maintenance parameter refers to various data based on which a signal lamp maintenance and repair operation is performed. In some embodiments, the maintenance parameter includes a maintenance sequence, a maintenance time, a remote fine-tuning parameter, and a frequency adjustment parameter.

The maintenance sequence refers to an execution order planned for a plurality of signal lamp maintenance tasks to optimize maintenance efficiency and ensure traffic operation. The maintenance time refers to a specific time window planned for the abnormal signal lamp to perform maintenance. The time window refers to a time period with clear start and end points. The remote fine-tuning parameter refers to a collection of various instructions and values for configuring, calibrating, or controlling a signal lamp or its control device through a remote connection. For example, adjusting the driving current of a signal lamp A up to 250 mA or activating a third-phase controller, or the like. The frequency adjustment parameter refers to a parameter for adjusting a monitoring strategy to closely monitor the status of the abnormal signal lamp. For example, the data acquisition frequency of the abnormal signal lamp is increased from once every 10 minutes to once every 30 seconds.

In some embodiments, the emergency supervision and management platform may determine the maintenance parameter based on the fault prediction condition of the abnormal signal lamp in various ways and send it to the maintenance personnel. For example, the emergency supervision and management platform sorts a plurality of abnormal signal lamps according to magnitudes of their fault probabilities in a descending order, as a priority queue for maintenance, and, based on the priority queue, determines a maintenance sequence, a maintenance time, or the like in the maintenance parameter by an existing path planning algorithm.

The maintenance personnel refers to technical personnel or a team responsible for operation and maintenance of a signal lamp system.

In some embodiments, maintenance instructions including the detailed maintenance parameters may be sent to the relevant maintenance personnel through means such as a work order system, mobile Application (APP) push, SMS messages, or the like, to guide them to complete on-site operations.

In some embodiments, the emergency supervision and management platform is further configured to: in response to the fault prediction condition including the component aging or the communication abnormality, determine the remote fine-tuning parameter according to the fault prediction condition; send the remote instruction to the abnormal signal lamp to adjust a magnitude of the driving current of the abnormal signal lamp based on the remote fine-tuning parameter, and/or reset the communication module of the abnormal signal lamp. For more details on the component aging and the communication abnormality, refer to Step 240 and its related description.

In some embodiments, the emergency supervision and management platform may determine the remote fine-tuning parameter based on the fault prediction condition in various ways. In some embodiments, the emergency supervision and management platform may determine the remote fine-tuning parameter based on the fault prediction condition and a fault strategy mapping table.

The fault strategy mapping table includes a correspondence between different fault types and different remote fine-tuning parameters. The emergency supervision and management platform may determine the fault strategy mapping table based on historical remote fine-tuning parameters that have been issued for different fault types in the historical data, and that have extended a service life of a signal lamp (for example, the signal lamp is normally used within a preset continuous period and is not determined as a faulty signal lamp). The emergency supervision and management platform may determine the remote fine-tuning parameter corresponding to the current abnormal signal lamp based on the fault type corresponding to the abnormal signal lamp by querying the fault strategy mapping table.

The remote instruction refers to a control instruction sent by the emergency supervision and management platform to the abnormal signal lamp for implementing status regulation or function execution. In some embodiments, the emergency supervision and management platform sends the instruction package encapsulating the remote fine-tuning parameter to the ECU of the abnormal signal lamp through means such as a wired or wireless communication network, or the like. The instruction package adopts a predefined protocol format to ensure accurate parsing and secure execution of the instruction.

The driving current refers to a working current output by a driving power supply and applied to a lamp group to ensure normal illumination and stable operation of a signal lamp.

In some embodiments, after receiving the remote instruction, the ECU of the abnormal signal lamp adjusts an output power of a driving circuit connected to an LED lamp bead through the digital or analog output interface of the ECU, so that the driving current is stabilized at a target value specified by the remote fine-tuning parameter. For example, fine-tuning a lamp bead current with reduced brightness due to aging from a rated 200 mA to 220 mA, to compensate for light decay and restore a rated brightness.

In some embodiments, the emergency supervision and management platform may determine the adjusted driving current of the abnormal signal lamp according to the following formula (2):

l′=l×(1+α) (2).

In formula (2), l′ represents the adjusted driving current of the abnormal signal lamp; l represents the driving current of the abnormal signal lamp before adjustment; and α represents the abnormality degree of the abnormal signal lamp. In some embodiments, after receiving the remote instruction, the ECU of the abnormal signal lamp performs an operation of power-off restart, software reset, or factory network configuration restoration on the integrated or external communication module to clear a temporary software fault or a state lock-up of the communication module, and re-establish a stable communication connection with the emergency supervision and management platform.

In some embodiments of the present disclosure, the emergency supervision and management platform fine-tunes the abnormal signal lamp through the remote fine-tuning parameter, such as increasing the driving current, resetting the communication module, or the like, which may temporarily reset a working status or extend an effective working life to gain time for the maintenance personnel.

In some embodiments, the maintenance parameter includes a frequency adjustment parameter. The emergency supervision and management platform is further configured to: determine the frequency adjustment parameter based on the maintenance time; and send an acquisition instruction to the ECU based on the frequency adjustment parameter to adjust the data acquisition frequency of the abnormal signal lamp.

In some embodiments. The emergency supervision and management platform may determine the adjusted acquisition frequency parameter according to the following formula (3):

f_new=_old×(1+e^{(-t)}) (3).

In formula (3), f_new represents the adjusted acquisition frequency parameter of the abnormal signal lamp; f_old represents the acquisition frequency parameter of the abnormal signal lamp before adjustment; and t represents a time interval between a start time of the maintenance time and a current moment.

The acquisition instruction is a structured instruction generated by the emergency supervision and management platform and encapsulating the frequency adjustment parameter. In some embodiments, the acquisition instruction specifies the abnormal signal lamp, data types to be adjusted (for example, current, voltage), and new acquisition and/or reporting frequency values.

For more details on the ECU, refer to Step 240 and its related description.

In some embodiments, after receiving the acquisition instruction, an embedded agent program of the ECU parses the content of the instruction and dynamically adjusts a scheduling period of a data acquisition task of the ECU accordingly. For example, the edge computing unit may reconfigure a timer according to new frequency parameters (for example, a 30-second interval), to read data from a specified sensor or a device register at a frequency in the frequency adjustment parameter, thereby realizing fine-grained, real-time monitoring of the running status of the abnormal signal lamp.

In some embodiments of the present disclosure, the emergency supervision and management platform may effectively capture more transient abnormal data and performance fluctuation characteristics by increasing the acquisition frequency within a time window for device maintenance, thereby providing more complete and timely data support for fault diagnosis and analysis; meanwhile, this adaptive adjustment mechanism avoids resource waste caused by continuous high-frequency acquisition, enabling the ECU to maintain efficient operation while ensuring a monitoring effect, and achieving a balance between precise monitoring and resource utilization.

In some embodiments of the present disclosure, the emergency supervision and management platform, by fusing the first and second monitoring data acquired by different sensing devices, realizes precise diagnosis and grading of a running status of a signal lamp: for a signal lamp that has already failed, the system can immediately perform power cut-off and detour suggestion issuance, effectively ensuring road safety; for the abnormal signal lamp with potential risks, the fault prediction is performed based on multi-dimensional data, and the precise maintenance parameters are generated to guide maintenance work. This hierarchical disposition mechanism not only ensures a quick response to severe faults, but also realizes early warning and proactive intervention for potential faults, thereby significantly improving the intelligence level of urban traffic management and emergency response efficiency and ultimately building a safe, efficient, and reliable urban signal lamp operation and maintenance system.

FIG. 3 is an exemplary schematic diagram of a first machine learning model according to some embodiments of the present disclosure.

In some embodiments, the emergency supervision and management platform may also predict a fault probability 360 and a fault type 350 of an abnormal signal lamp by a first machine learning model 340 based on first monitoring data 310, second monitoring data 320, and a status evaluation result 330 of the abnormal signal lamp.

For more information regarding the abnormal signal lamp, the first monitoring data, the second monitoring data, the status evaluation result, and the fault type, refer to FIG. 2 and its related description.

In some embodiments, the first machine learning model may only select the fault type with the highest probability among predicted fault types that may occur within a future preset time period as an output. For example, LED module aging, controller communication abnormality, or the like. The preset time period may be preset by a technical personnel according to experience.

The fault probability refers to a probability corresponding to a fault that may occur within the future preset time period predicted by the first machine learning model for the abnormal signal lamp. The fault probability may be expressed as a percentage value. For example, the first machine learning model predicts that a probability of the controller communication abnormality occurring in the abnormal signal lamp within the future preset time period is 50%.

The first machine learning model refers to a model used for predicting the fault probability and the fault type of the abnormal signal lamp. In some embodiments, the first machine learning model is a machine learning model. For example, the first machine learning model may include a combination of one or more of a Recurrent Neural Network (RNN) model, a Long Short-Term Memory (LSTM) model, other customized models, or the like.

In some embodiments, an input of the first machine learning model may include the first monitoring data, the second monitoring data, and the status evaluation result of the abnormal signal lamp, and an output of the first machine learning model may include the fault probability and the fault type of the abnormal signal lamp.

In some embodiments, the first machine learning model may be obtained through training an initial first machine learning model by first training samples with first labels. The first training sample may include the first monitoring data, the status evaluation result, and the second monitoring data corresponding to a sample signal lamp at a first historical time point. A first label may include a sample fault type and a sample fault probability corresponding to the sample fault type that occurs in the sample signal lamp within the preset time period after the first historical time point under the first training sample.

In some embodiments, the first training samples and the first labels may be obtained based on the historical data. For example, the emergency supervision and management platform may select a plurality of sample signal lamps from historical data that have the same or similar first monitoring data, status evaluation result, and second monitoring data at the first historical time point, use the fault types that occur in the plurality of sample signal lamps within the preset time period after the first historical time point as the sample fault type; and use a ratio of a count of the plurality of sample signal lamps where the same fault type occurs within the preset time period after the first historical time point to a total count of the plurality of sample signal lamps as a sample fault probability of the fault type.

In some embodiments, the emergency supervision and management platform may input a plurality of first training samples with first labels into the initial first machine learning model, obtain the sample fault type and the sample fault probability corresponding to the sample fault type output by the initial first machine learning model, construct a loss function through the label and the output of the initial first machine learning model, and iteratively update parameters of the initial first machine learning model based on the loss function through gradient descent, a simulated annealing algorithm, or other manners. When a preset condition is satisfied, the model training is completed, and a trained first machine learning model is obtained. The preset condition may include loss function convergence, a count of iterations reaching a threshold, or the like.

In some embodiments of the present disclosure, by introducing the first machine learning model, the system for emergency management of traffic signal lamp faults based on the Internet of Things large model can foresee specific problems that may occur in the signal lamps, fundamentally changing a traditional passive maintenance manner after finding a fault to a preventative maintenance manner of actively intervening after predicting potential faults, thereby significantly improving operation and maintenance efficiency.

In some embodiments, the input of the first machine learning model may also include the first monitoring data of other signal lamps (if present) at the intersection where the abnormal signal lamp is located, and the training sample of the first machine learning model may also include sample first monitoring data of the other signal lamps (if present) at the intersection where the sample signal lamp is located at the first historical time point.

In some embodiments of the present disclosure, a cross-signal lamp collaborative analysis within the same intersection can identify systemic or correlated problems that cannot be reflected by single lamp data, can more accurately determine whether an abnormality comes from the signal lamp itself or from a common device of the intersection (such as a power supply cabinet or a controller), thereby improving an accuracy of fault localization and reducing a possibility of misdiagnosis.

The adjacent intersection signal lamp of the abnormal signal lamp refers to a signal lamp whose the intersection is an adjacent intersection to the intersection where the abnormal signal lamp is located.

In some embodiments, the input of the first machine learning model may also include the first monitoring data of the adjacent intersection signal lamp (if present) of the abnormal signal lamp, and the training sample of the first machine learning model may also include sample first monitoring data of the adjacent intersection signal lamp (if present) of the sample signal lamp at the first historical time point.

In some embodiments of the present disclosure, a cross-signal lamp collaborative analysis across different intersections enables the system for emergency management of traffic signal lamp faults based on the Internet of Things large model to have a global perspective, and can place an abnormality of a single signal lamp into a more macroscopic network for analysis. This effectively eliminates environmental interference, improves a robustness of fault prediction, and ensures a reliability and practicality of prediction results.

In some embodiments, the output of the first machine learning model may also include the fault time; the maintenance parameter includes the maintenance sequence, the maintenance time, and the data acquisition frequency of the abnormal signal lamp; the emergency supervision and management platform may also determine the maintenance sequence and the maintenance time of the abnormal signal lamp based on the fault time; and adjust the data acquisition frequency of the abnormal signal lamp based on the maintenance time.

In some embodiments, a label of the first machine learning model may also include a sample fault time. The sample fault time may be obtained from the historical data. For example, the emergency supervision and management platform may select the plurality of sample signal lamps that have the same or similar first monitoring data, status evaluation result, and second monitoring data at the first historical time point, obtain the fault times when the same sample fault type occurs in the plurality of sample signal lamps within the preset time period after the first historical time point, and use an average value of the fault times as the sample fault time corresponding to the sample fault type.

For more information regarding the maintenance sequence, the maintenance time, and the data acquisition frequency, reference may be made to FIG. 2 and its related description.

The fault time refers to a time interval between a fault occurrence time predicted by the first machine learning model and a current time.

In some embodiments, the smaller the fault time of the abnormal signal lamp is, the higher the maintenance sequence priority of the abnormal signal lamp is.

In some embodiments, the emergency supervision and management platform may also perform weighted sorting in combination with an importance degree of the intersection, and reconfirm the maintenance sequence.

The importance degree of the intersection refers to a quantitative indicator used for determining maintenance priority sorting, and may be defined by comprehensively evaluating a criticality of the intersection in a traffic network, and may include traffic flow, historical accident rate, or the like. For example, the larger the traffic flow of a certain intersection is, the higher the maintenance sequence priority is. For example, the higher the historical accident rate of a certain intersection is, the higher the maintenance sequence priority is.

In some embodiments, when the maintenance time approaches, the emergency supervision and management platform may automatically send an instruction to the ECU, and increase the data acquisition frequency of the abnormal signal lamp from a minute level to a second level, so that the maintenance personnel can obtain more refined and richer real-time data before arriving at the site, which helps rapid diagnosis.

In some embodiments, according to the predicted fault type, the emergency supervision and management platform may also send a remote diagnosis instruction to the ECU. The remote diagnosis instruction may trigger a signal lamp controller to execute a deeper self-check program, read lower-level operation logs and parameters, or even perform remote fine-tuning of some parameters. For example, the signal lamp controller may perform parameter optimization and communication protocol optimization.

In some embodiments, if the predicted fault type is a brightness abnormality caused by ‘minor aging of an LED module’, on a premise of not affecting visibility, the emergency supervision and management platform may issue the remote instruction to an LED driving module, increase an output current according to a degree of brightness abnormality to compensate for brightness attenuation, extend an effective working life thereof, and gain a maintenance time window.

In some embodiments, if the predicted fault type is ‘controller communication abnormality’, the emergency supervision and management platform may remotely reset the communication module, or adjust communication parameters of the communication module (such as a baud rate, a retransmission mechanism, or the like) to try to restore a stable connection of the communication module.

In some embodiments of the present disclosure, the first machine learning model can not only output where a fault may occur, but also can output when to perform maintenance and how to perform maintenance, thereby realizing fine-grained scheduling of predictive maintenance and a closed loop from prediction to action. Meanwhile, the remote fine-tuning can enable alleviating fault problems to a certain extent without sending personnel to a site, gaining the valuable maintenance time window, reducing a frequency and a difficulty of on-site maintenance, and greatly improving operation and maintenance efficiency and resource utilization rate.

In some embodiments, the emergency supervision and management platform is further configured to: determine a coordination parameter of an associated signal lamp of an associated intersection around the faulty signal lamp, and send the coordination parameter to the associated signal lamp, wherein the coordination parameter includes a timing parameter of the associated signal lamp; the associated signal lamp is configured to: according to the timing parameter, trigger a sub-clock at a start time of each color lamp, and control a relay group to conduct a bulb through cyclic control to drive different bulbs to emit light alternately.

The associated intersection around the faulty signal lamp refers to an adjacent intersection that has a direct traffic flow association with the intersection where the faulty signal lamp is located. For example, an intersection located on the same main road as the faulty signal lamp, or an intersection connected by a branch road.

In some embodiments, the emergency supervision and management platform may, based on geographical information, road network topology, and historical traffic data, determine the associated intersections around the faulty signal lamp that have a direct or indirect traffic association with the faulty signal lamp.

The associated signal lamp refers to the signal lamp installed at the associated intersection around the faulty signal lamp. In some embodiments, an operating status of the associated signal lamp needs to be coordinated with the fault signal lamp.

The coordination parameter refers to an instruction parameter used for enabling collaborative operation of regional signal lamps. For example, a phase difference, a cycle duration, a green ratio, or the like.

In some embodiments, the emergency supervision and management platform may generate the coordination parameter through prior experience, based on the vehicle traffic flow, average vehicle speed, queue length, and vehicle type distribution of the associated intersection around the faulty signal lamp.

In some embodiments, the emergency supervision and management platform may send the coordination parameter to an ECU of the associated signal lamp in the form of an encrypted data packet via a city-dedicated network or a wireless communication network (e.g., 5G). The sending process adopts a ‘request-acknowledgment’ mechanism to ensure reliable delivery of the instruction, and updates a signal lamp status log in the emergency supervision and management platform after successful delivery.

In some embodiments, the coordination parameter includes the timing parameter, a phase parameter, and a special mode.

The timing parameter refers to the start time and the duration of the signal lamp in different color (e.g., red light, green light, yellow light) states. In some embodiments, the emergency supervision and management platform may dynamically adjust the timing parameter according to different needs of traffic conditions, including but not limited to the following manners:

Diversion: by appropriately shortening the green light duration of the associated signal lamp in an upstream direction of the faulty intersection to reduce the traffic flow entering the faulty intersection, thereby guiding vehicles to select an alternative route for detour in advance; Relief: by extending the green light duration of the associated signal lamp in a downstream direction of the faulty intersection to accelerate the passing speed of vehicles that have entered the intersection or nearby areas, and to improve evacuation efficiency; Balance: by comprehensively considering the timing schemes of the associated signal lamps of a plurality of adjacent intersections within a regional scope, and by coordinating a ratio of green lights and red lights of each intersection, to achieve overall balance and stability of the traffic flow.

The phase parameter refers to a parameter that controls a release sequence and a switching manner of each traffic direction. In some embodiments, by adjusting the phase parameter, a passing order of vehicles and pedestrians can be changed, and traffic flow organization can be optimized. For example, based on control of the associated signal lamps of the associated intersections around the faulty signal lamp, the traffic flow in a main road direction may be prioritized for release, or a sequence of left-turn, straight-through, and right-turn releases of the intersection may be adjusted to alleviate local congestion.

The special mode refers to an unconventional signal control manner activated under specific circumstances, to satisfy special traffic demands or emergency management objectives. For example, a green wave system may be activated to improve main road traffic efficiency, a two-way traffic mode may be initiated to temporarily alleviate traffic pressure on a one-way road, or a green channel may be opened for emergency vehicles (e.g., ambulances, fire trucks), to ensure fast and safe passage.

In some embodiments, the emergency supervision and management platform may construct a first feature vector based on the traffic flow of the associated intersections around the current faulty signal lamp, the fault type of the current faulty signal lamp, and the fault time of the current faulty signal lamp; perform vector matching in a first vector database based on the first feature vector, to determine a first associated vector.

In some embodiments, various ways may be used for constructing the first feature vector. For example, the first feature vector may be constructed in manners such as Term Frequency-Inverse Document Frequency (TF-IDF), One-Hot, Word2Vec, or the like. The first vector database may include a plurality of first reference vectors and corresponding reference timing parameters. Each of the first reference vectors may be constructed based on historical traffic flow, historical fault types, and historical fault times. A construction manner of the first reference vector is similar to that of the first feature vector. The reference timing parameter may be the actual timing parameter corresponding to the first reference vector. The actual timing parameter refers to a historical timing parameter corresponding to the first reference vector, which successfully clears traffic and has no congestion status.

In some embodiments, the emergency supervision and management platform may, through vector matching, determine the first reference vector that satisfies the first preset condition as the first associated vector. The first preset condition may refer to the preset condition used for determining the first associated vector. In some embodiments, the first preset condition may include a vector distance satisfying less than a distance threshold, the vector distance being minimized, or the like. The emergency supervision and management platform may use the reference timing parameter corresponding to the first associated vector as the timing parameter in the coordination parameter sent to the associated signal lamp.

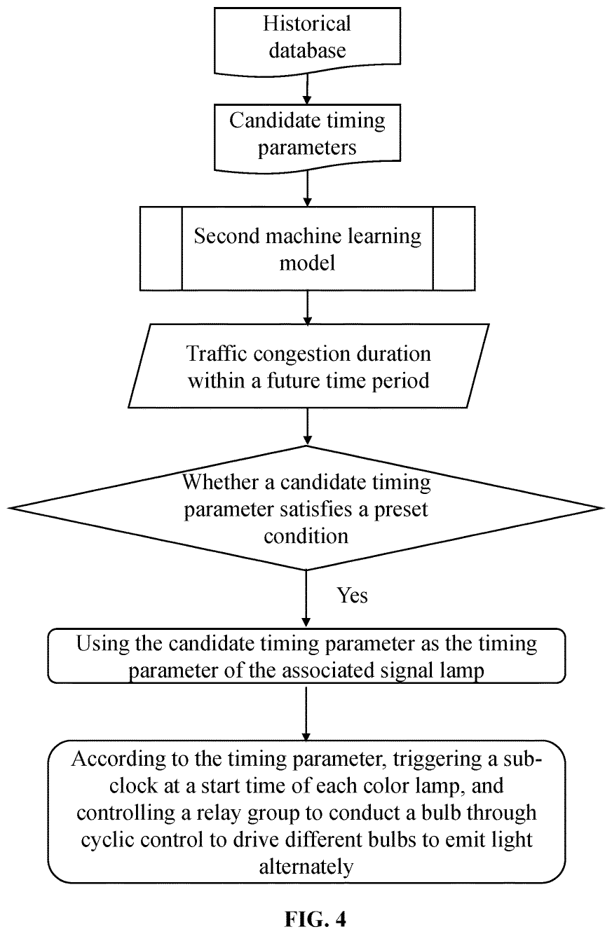

FIG. 4 is an exemplary schematic diagram of control of an associated signal lamp according to some embodiments of the present disclosure.

In some embodiments, the emergency supervision and management platform is further configured to: generate candidate timing parameters based on a historical database; predict a traffic congestion duration corresponding to each of the candidate timing parameters within a future time period by a second machine learning model; and use a candidate timing parameter of the candidate timing parameters, for which the traffic congestion duration satisfies the preset condition, as the timing parameter of the associated signal lamp.

The historical database refers to a structured data collection that stores multi-dimensional historical data related to traffic operations. In some embodiments, the historical database includes historical traffic flows, historical fault types, and historical fault times of intersections where various signal lamps are located, or the like. In some embodiments, the historical database includes the aforementioned first vector database. The candidate timing parameters refer to the reference timing parameters corresponding to a plurality of first associated vectors that satisfy the first preset condition.

The traffic congestion duration within the future time period refers to a predicted cumulative duration during which traffic flow data of vehicles at the associated intersection around the faulty signal lamp is lower than a preset threshold within a specific future time period (e.g., the next 30 minutes), when the associated signal lamp of the associated intersection around the faulty signal lamp executes the candidate timing parameter. The preset threshold may be set according to the experience of a person skilled in the art. For more details regarding traffic flow data, refer to step 210 and its related descriptions.

The second machine learning model refers to a machine learning model used for predicting the traffic congestion duration corresponding to the candidate timing parameter within the future time period. For example, the second machine learning model may include a combination of one or more of RNN models, LSTM models, or other customized models, or the like.

In some embodiments, an input of the second machine learning model may be the candidate timing parameter and the traffic flow data of the associated intersection of the faulty signal lamp. An output of the second machine learning model may be the traffic congestion duration corresponding to the candidate timing parameter. For more details regarding traffic flow data, refer to step 210 and its related descriptions.

In some embodiments, the second machine learning model may be obtained by training an initial second machine learning model through a plurality of second training samples with second labels. The second training samples may include sample timing parameters executed by sample associated signal lamps of sample faulty signal lamps, and sample traffic flow data of the sample associated signal lamps. The second labels may include the traffic congestion duration when the sample associated signal lamps execute the sample timing parameters.

In some embodiments, the second training samples and the second labels may be obtained based on historical data.

A training process of the second machine learning model is similar to the training process of the first machine learning model, and for a specific training process, refer to the training process of the first machine learning model.

The preset condition refers to an evaluation criterion set for screening an optimal candidate timing parameter. For example, the preset condition may be a minimum traffic congestion duration.

In some embodiments, the emergency supervision and management platform may compare a plurality of candidate timing parameters output by the second machine learning model and their corresponding traffic congestion durations, and select the candidate timing parameter with the shortest traffic congestion duration as the timing parameter of the associated signal lamp.

In some embodiments of the present disclosure, the emergency supervision and management platform, through simulation and prediction capabilities of the second machine learning model, can foreseeably select an optimal timing scheme, instead of merely adjusting according to preset rules. This ensures that under complex traffic conditions, the most effective solution can be found to minimize congestion, and real intelligent traffic collaborative scheduling can be achieved.

The start time refers to an initial moment when each color lamp is illuminated within a complete cycle of the signal lamp.

The sub-clock refers to a logical functional unit that generates an independent timing sequence for a single signal lamp group and can achieve phase difference control by setting a start delay.

The relay group refers to a collection of electrical switch components used for safely driving high-power signal lamp illumination through a low-power control circuit. In some embodiments, the relay group activates a physical switch by energizing a coil to connect an external strong current circuit.

In some embodiments, the emergency supervision and management platform, based on the timing parameter, triggers the sub-clock at the start time of each color lamp, and controls the relay group to conduct the bulb through cyclic control, to drive different bulbs to emit light alternately. For example, after the associated signal lamp receives the timing parameter, it parses the timing parameter, obtains the start time and the duration of each color lamp, and configures the corresponding sub-clock accordingly. When a main clock runs to a green light start time, the green light sub-clock is triggered, a green light relay is turned on, and a green light is illuminated; after the green light sub-clock timing ends, a yellow light sub-clock is triggered, switching to a yellow light relay, and a yellow light is illuminated; after the yellow light sub-clock timing ends, a red light sub-clock is triggered, switching to a red light relay, and a red light is illuminated. In this manner, the cycle repeats, forming a complete signal cycle, and ensures that each color bulb emits light alternately in a precise and orderly manner according to timing parameter requirements.

In some embodiments of the present disclosure, when the fault occurs, the emergency supervision and management platform sends the coordination parameter to the associated signal lamp, and the associated signal lamp precisely executes a new timing scheme through sub-clock triggering and relay group control. This mechanism can effectively disperse traffic pressure at fault points, guide vehicles for diversion, and avoid regional traffic congestion caused by local faults, thereby significantly improving the overall traffic efficiency of a road network.

The basic concepts have been described above. Clearly, for the person skilled in the art, the detailed disclosure described above is merely by way of example and is not intended to limit the present disclosure. Although not explicitly stated herein, the person skilled in the art may make various modifications, improvements, and amendments to the present disclosure. Such modifications, improvements, and amendments are contemplated in the present disclosure. Therefore, such modifications, improvements, and amendments still fall within the spirit and scope of the exemplary embodiments of the present disclosure.

Finally, it should be understood that the embodiments described in the present disclosure are merely by way of example for illustrating the principles of the embodiments of the present disclosure. Other variations may also fall within the scope of the present disclosure. Therefore, by way of example, and not by way of limitation, alternative configurations of the embodiments of the present disclosure may be considered as consistent with teachings of the present disclosure. Accordingly, the embodiments of the present disclosure are not limited to the embodiments explicitly introduced and described in the present disclosure.

What is claimed is:

1. A system for emergency management of traffic signal lamp faults based on an Internet of Things large model, comprising an emergency supervision and management platform, wherein the emergency supervision and management platform is configured to:
determine a status evaluation result of a signal lamp based on first monitoring data and second monitoring data of the signal lamp, wherein the first monitoring data and the second monitoring data are acquired by different sensing devices;
determine a target signal lamp based on the status evaluation result, wherein the target signal lamp includes a faulty signal lamp and an abnormal signal lamp;
cut off a power supply of the faulty signal lamp and issue a detour suggestion to a target personnel;
determine a fault prediction condition of the abnormal signal lamp based on the first monitoring data, the second monitoring data, and the status evaluation result of the abnormal signal lamp; and
determine a maintenance parameter based on the fault prediction condition and send the maintenance parameter to a maintenance personnel.

2. The system according to claim 1, wherein a determination of the abnormal signal lamp is related to a traffic flow of an intersection where the abnormal signal lamp is located and a historical accident count.

3. The system according to claim 1, wherein the maintenance parameter includes a remote fine-tuning parameter; and the emergency supervision and management platform is further configured to:
in response to the fault prediction condition including component aging or a communication abnormality, determine the remote fine-tuning parameter according to the fault prediction condition; and
send a remote instruction to the abnormal signal lamp to adjust a magnitude of a driving current of the abnormal signal lamp based on the remote fine-tuning parameter, and/or reset a communication module of the abnormal signal lamp.

4. The system according to claim 1, wherein the maintenance parameter includes a frequency adjustment parameter; and the emergency supervision and management platform is further configured to:
determine the frequency adjustment parameter based on a maintenance time; and
send an acquisition instruction to an edge computing unit based on the frequency adjustment parameter to adjust a data acquisition frequency of the abnormal signal lamp.

5. The system according to claim 1, wherein the status evaluation result includes a fault status and an abnormality degree; and the emergency supervision and management platform is further configured to:
determine an initial evaluation result of the signal lamp based on the first monitoring data;
verify the initial evaluation result based on the second monitoring data; and
use the initial evaluation result that passes the verification as the status evaluation result.

6. The system according to claim 1, wherein the emergency supervision and management platform is further configured to:
predict a fault probability and a fault type of the abnormal signal lamp by a first machine learning model based on the first monitoring data, the second monitoring data, and the status evaluation result of the abnormal signal lamp.

7. The system according to claim 6, wherein an input of the first machine learning model further includes: first monitoring data of other signal lamps at an intersection where the abnormal signal lamp is located or first monitoring data of an adjacent intersection signal lamp of the abnormal signal lamp.

8. The system according to claim 6, wherein an output of the first machine learning model further includes a fault time; the maintenance parameter includes a maintenance sequence, a maintenance time, and a data acquisition frequency of the abnormal signal lamp;
and the emergency supervision and management platform is further configured to:
determine the maintenance sequence and the maintenance time of the abnormal signal lamp based on the fault time; and
adjust the data acquisition frequency of the abnormal signal lamp based on the maintenance time.

9. The system according to claim 1, wherein the emergency supervision and management platform is further configured to:
determine a coordination parameter of an associated signal lamp of an associated intersection around the faulty signal lamp and send the coordination parameter to the associated signal lamp, wherein the coordination parameter includes a timing parameter of the associated signal lamp;
wherein the associated signal lamp is configured to: according to the timing parameter, trigger a sub-clock at a start time of each color lamp, and control a relay group to conduct a bulb through cyclic control to drive different bulbs to emit light alternately.

10. The system according to claim 9, wherein the emergency supervision and management platform is further configured to:
generate candidate timing parameters based on a historical database;
predict a traffic congestion duration corresponding to each of the candidate timing parameters within a future time period by a second machine learning model; and
use a candidate timing parameter of the candidate timing parameters, for which the traffic congestion duration satisfies a preset condition, as the timing parameter of the associated signal lamp.

11. A method for emergency management of traffic signal lamp faults based on an Internet of Things large model, wherein the method is executed by an emergency supervision and management platform and comprises:
determining a status evaluation result of a signal lamp based on first monitoring data and second monitoring data of the signal lamp, wherein the first monitoring data and the second monitoring data are acquired by different sensing devices;
determining a target signal lamp based on the status evaluation result, wherein the target signal lamp includes a faulty signal lamp and an abnormal signal lamp;
cutting off a power supply of the faulty signal lamp and issuing a detour suggestion to a target personnel;
determining a fault prediction condition of the abnormal signal lamp based on the first monitoring data, the second monitoring data, and the status evaluation result of the abnormal signal lamp; and
determining a maintenance parameter based on the fault prediction condition and sending the maintenance parameter to a maintenance personnel.

12. The method according to claim 11, wherein a determination of the abnormal signal lamp is related to a traffic flow of an intersection where the abnormal signal lamp is located and a historical accident count.

13. The method according to claim 11, wherein the maintenance parameter includes a remote fine-tuning parameter; and the method further comprises:
in response to the fault prediction condition including component aging or a communication abnormality, determining the remote fine-tuning parameter according to the fault prediction condition; and
sending a remote instruction to the abnormal signal lamp to adjust a magnitude of a driving current of the abnormal signal lamp based on the remote fine-tuning parameter, and/or resetting a communication module of the abnormal signal lamp.

14. The method according to claim 11, wherein the maintenance parameter includes a frequency adjustment parameter; and the method further comprises:
determining the frequency adjustment parameter based on a maintenance time; and
sending an acquisition instruction to an edge computing unit based on the frequency adjustment parameter to adjust a data acquisition frequency of the abnormal signal lamp.

15. The method according to claim 11, wherein the status evaluation result includes a fault status and an abnormality degree; and the determining the status evaluation result of the signal lamp based on the first monitoring data and the second monitoring data of the signal lamp further includes:
determining an initial evaluation result of the signal lamp based on the first monitoring data;
verifying the initial evaluation result based on the second monitoring data; and
using the initial evaluation result that passes the verification as the status evaluation result.

16. The method according to claim 11, wherein the determining the fault prediction condition of the abnormal signal lamp based on the first monitoring data, the second monitoring data, and the status evaluation result of the abnormal signal lamp further includes:
predicting a fault probability and a fault type of the abnormal signal lamp by a first machine learning model based on the first monitoring data, the second monitoring data, and the status evaluation result of the abnormal signal lamp.

17. The method according to claim 16, wherein an input of the first machine learning model further includes: first monitoring data of other signal lamps at an intersection where the abnormal signal lamp is located or first monitoring data of an adjacent intersection signal lamp of the abnormal signal lamp.

18. The method according to claim 16, wherein an output of the first machine learning model further includes a fault time; the maintenance parameter includes a maintenance sequence, a maintenance time, and a data acquisition frequency of the abnormal signal lamp;
the determining the maintenance parameter based on the fault prediction condition includes:
determining the maintenance sequence and the maintenance time of the abnormal signal lamp based on the fault time; and
adjusting the data acquisition frequency of the abnormal signal lamp based on the maintenance time.

19. The method according to claim 11, wherein the method further comprises:
determining a coordination parameter of an associated signal lamp of an associated intersection around the faulty signal lamp, and sending the coordination parameter to the associated signal lamp, wherein the coordination parameter includes a timing parameter of the associated signal lamp;
the associated signal lamp is configured to: according to the timing parameter, trigger a sub-clock at a start time of each color lamp, and control a relay group to conduct a bulb through cyclic control to drive different bulbs to emit light alternately.

20. The method according to claim 19, wherein the determining the coordination parameter of the associated signal lamp of the associated intersection around the faulty signal lamp includes:
generating candidate timing parameters based on a historical database;
predicting a traffic congestion duration corresponding to each of the candidate timing parameters within a future time period by a second machine learning model; and
using a candidate timing parameter of the candidate timing parameters, for which the traffic congestion duration satisfies a preset condition, as the timing parameter of the associated signal lamp.
